(19) United States
(12) Patent Application Publication
(10) Pub. No.: US 2026/0243961 A1
(43) Pub. Date: Aug. 20, 2026

(54) MULTICORE FIBER CONNECTOR AND OPTICAL COMMUNICATION SYSTEM

(71) Applicant: Lightera Japan Co., Ltd., Tokyo (JP)

(72) Inventor: Kazunori MUKASA, Tokyo (JP)

(73) Assignee: Lightera Japan Co., Ltd., Tokyo (JP)

(21) Appl. No.: 19/542,954

(22) Filed: Feb. 18, 2026

(30) Foreign Application Priority Data
Feb. 20, 2025 (JP) 2025-026265

(51) Int. Cl. G02B 6/255

(52) U.S. Cl. CPC G02B 6/255

(57) ABSTRACT

A multicore fiber connector includes: a first multicore fiber including a plurality of cores including a first core whose effective core area at a predetermined wavelength is equal to a first value, and a cladding portion surrounding the plurality of cores; and a second multicore fiber including a plurality of cores including a second core whose effective core area at the predetermined wavelength is equal to a second value which is smaller than the first value, and a cladding portion surrounding the plurality of cores, wherein the first core and the second core are connected to each other in series.

This application claims the benefit of priority from Japanese Patent Application No. 2025-026265 filed on Feb. 20, 2025, the entire contents of which are incorporated herein by reference.

### BACKGROUND

The present disclosure relates to a multicore fiber connector and an optical system.

In a multicore fiber that includes a plurality of cores, there are times when the crosstalk occurring among those cores presents a problem. As a method for solving that problem, there is a method by which heterogenous cores are used as the plurality of cores. Herein, heterogenous cores imply such cores whose effective refractive indices are different from each other (for example, refer to Japanese Patent No. 5168702).

Moreover, a technique is disclosed in which multicore fibers are used in the most appropriate way in accordance with the communication mode (such as bidirectional communication) (for example, refer to Imamura et al., “Multicore fiber for bi-directional transmission”, NEW GLASS, New Glass Forum, Vol. 31, No. 118, PP 8-11, 2016).

### SUMMARY

As far as the known configuration of a multicore fiber is concerned, there is room for improvement from the perspective of mitigating the effects of nonlinear optical phenomena occurring during optical communication.

There is a need for a multicore fiber connector that enables mitigating the effects of nonlinear optical phenomena occurring during optical communication, and an optical communication system including the multicore fiber connector.

According to one aspect of the present disclosure, there is provided a multicore fiber connector including: a first multicore fiber including a plurality of cores including a first core whose effective core area at a predetermined wavelength is equal to a first value, and a cladding portion surrounding the plurality of cores; and a second multicore fiber including a plurality of cores including a second core whose effective core area at the predetermined wavelength is equal to a second value which is smaller than the first value, and a cladding portion surrounding the plurality of cores, wherein the first core and the second core are connected to each other in series.

### BRIEF DESCRIPTION OF THE DRAWINGS

FIG. 1 is a schematic configuration diagram of an optical communication system in which a multicore fiber connector according to a first embodiment is used;

FIG. 2A and FIG. 2B are schematic cross-sectional views of multicore fibers, which are illustrated in FIG. 1, along the surface perpendicular to the longitudinal direction;

FIG. 3 is a diagram illustrating an example of the relationship between the difference in the effective core areas of the cores and the inter-core crosstalk;

FIG. 4 is a schematic configuration diagram of an optical communication system in which a multicore fiber connector according to a second embodiment is used;

FIG. 5A and FIG. 5B are schematic cross-sectional views of multicore fibers, which are illustrated in FIG. 4, along the surface perpendicular to the longitudinal direction;

FIG. 6 is a schematic configuration diagram of an optical communication system in which a multicore fiber connector according to a third embodiment is used;

FIG. 7A and FIG. 7B are schematic cross-sectional views of multicore fibers, which are illustrated in FIG. 6, along the surface perpendicular to the longitudinal direction;

FIG. 8 is a schematic configuration diagram of an optical communication system in which a multicore fiber connector according to a fourth embodiment is used;

FIG. 9A and FIG. 9B are schematic cross-sectional views of multicore fibers, which are illustrated in FIG. 8, along the surface perpendicular to the longitudinal direction;

FIG. 10 is a schematic configuration diagram of an optical communication system in which a multicore fiber connector according to a fifth embodiment is used;

FIG. 11A and FIG. 11B are schematic cross-sectional views of multicore fibers, which are illustrated in FIG. 10, along the surface perpendicular to the longitudinal direction;

FIG. 12 is a schematic configuration diagram of an optical communication system in which a multicore fiber connector according to a sixth embodiment is used;

FIG. 13A and FIG. 13B are schematic cross-sectional views of multicore fibers, which are illustrated in FIG. 12, along the surface perpendicular to the longitudinal direction;

FIG. 14 is a schematic configuration diagram of an optical communication system in which a multicore fiber connector according to a seventh embodiment is used; and FIG. 15A and FIG. 15B are schematic cross-sectional views of multicore fibers, which are illustrated in FIG. 14, along the surface perpendicular to the longitudinal direction.

### DETAILED DESCRIPTION

Exemplary embodiments are described below in detail with reference to the accompanying drawings. However, the present disclosure is not limited by the embodiments described below. In the drawings, identical or corresponding constituent elements are referred to by the same reference numerals, and their explanation is not given repeatedly. Moreover, in the specification, the cutoff wavelength or the effective cutoff wavelength implies the cable cutoff wavelength defined in ITU-T G. 650.1 of the International Telecommunications Union (ITU). Regarding the other terms that are not specifically defined in the present written description, it is assumed that the definitions and the measurement methods given in G. 650.1 and G. 650.2 are followed.

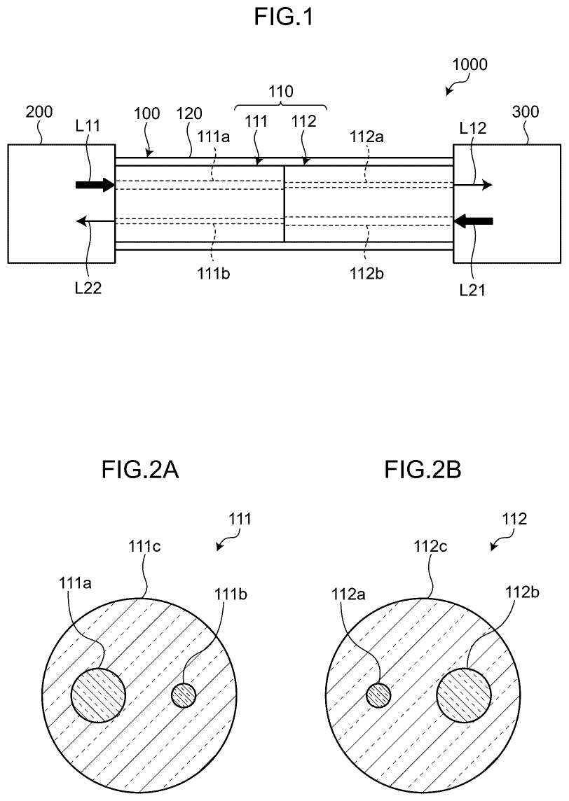

FIG. 1 is a schematic configuration diagram of an optical communication system in which a multicore fiber connector according to a first embodiment is used. An optical communication system 1000 is a bidirectional optical communication system that includes a multicore fiber cable 100 and communication devices 200 and 300.

The multicore fiber cable 100 includes a multicore fiber connector 110 according to the first embodiment and includes a structure 120. The structure 120 constitutes the multicore fiber cable 100, and is meant for supporting and protecting the multicore fiber connector 110. For example, the structure 120 includes a tension member and a sheath.

The multicore fiber connector 110 is configured when multicore fibers 111 and 112 are directly connected to each other in series.

FIG. 2A and FIG. 2B are schematic cross-sectional views of the multicore fibers, which are illustrated in FIG. 1, along the surface perpendicular to the longitudinal direction. FIG. 2A is a cross-sectional view of the multicore fiber 111, and FIG. 2B is a cross-sectional view of the multicore fiber 112.

The multicore fiber 111 is a 2-core multicore fiber that includes two cores 111a and 111b representing a plurality of cores and includes a cladding portion 111c which surrounds the cores 111a and 111b.

For example, the cores 111a and 111b have the refractive index profile of, what is called, the step-index type, or the W type, or the trench type. The cladding portion 111c has the average refractive index to be lower than the maximum refractive index of the cores 111a and 111b. In the case of having the trench-type refractive index profile, a core includes a center core, an intermediate layer surrounding the center core, and a trench layer surrounding the intermediate layer. The intermediate layer has the refractive index to be lower than the maximum refractive index of the center core, and the trench layer has the refractive index to be lower than the refractive index of the intermediate layer and the refractive index of the cladding portion.

The core 111a has the effective core area to be equal to a first value at a predetermined wavelength. The core 111b has the effective core area to be equal to a third value at the predetermined wavelength. The predetermined wavelength is included in such a wavelength band which is used for the wavelengths of the signal lights in the optical communication system 1000 (i.e., present within the operating wavelength band). The operating wavelength band is, for example, in the range from 1520 nm to 1620 nm. The predetermined wavelength is, for example, equal to 1550 nm.

The absolute value of the difference between the first value and the third value is greater than the third value by more than 10%.

The multicore fiber 111 explained above represents an example of a first multicore fiber; the core 111a represents an example of a first core; and the core 111b represents an example of a third core. Moreover, the cores 111a and 111b represent examples of two cores between which the absolute value of the difference in the effective core areas at the predetermined wavelength is greater than the smaller effective core area, from among the effective core areas of the two cores at the predetermined wavelength, by 10% or more.

The multicore fiber 112 is a 2-core multicore fiber that includes two cores 112a and 112b representing a plurality of cores and includes a cladding portion 112c that surrounds the cores 112a and 112b.

For example, the cores 112a and 112b have the refractive index profile of, what is called, the step-index type, or the W type, or the trench type. The cladding portion 112c has the average refractive index to be lower than the maximum refractive index of the cores 112a and 112b.

The core 112a has the effective core area to be equal to a second value at the predetermined wavelength. The second value is smaller than the first value which represents the effective core area of the core 111a at the predetermined wavelength. The core 112b has the effective core area to be equal to a fourth value at the predetermined wavelength. The fourth value is greater than the third value which represents the effective core area of the core 111b at the predetermined wavelength.

The absolute value of the difference between the second value and the fourth value is greater than the second value by 10% or more.

The multicore fiber 112 explained above represents an example of a second multicore fiber; the core 112a represents an example of a second core; and the core 112b represents an example of a fourth core. Moreover, the cores 112a and 112b represent examples of two cores between which the absolute value of the difference in the effective core areas at the predetermined wavelength is greater than the smaller effective core area, from among the effective core areas of the two cores at the predetermined wavelength, by 10% or more.

As illustrated in FIG. 1, the cores 111a and 112a are directly connected to each other in series. Moreover, the cores 111b and 112b are directly connected to each other in series.

The communication devices 200 and 300 have a known configuration used in the bidirectional communication method implemented in optical fiber communication. The communication device 200 is connected to the multicore fiber cable 100 on the side of the multicore fiber 111. The communication device 300 is connected to the multicore fiber cable 100 on the side of the multicore fiber 112. The communication device 200 represents an example of a first communication device, and the communication device 300 represents an example of a second communication device.

The communication device 200 outputs a signal light L11, which has the predetermined wavelength, to the core 111a of the multicore fiber 111. The signal light L11 represents an example of a first signal light. The core 111a transmits the signal light L11 and outputs it to the core 112a of the multicore fiber 112. The core 112a transmits the signal light L11 which has already propagated through the core 111a.

The communication device 300 receives a signal light L12 that represents the signal light L11 after it has propagated firstly through the core 111a and then through the core 112a. While sequentially propagating through the cores 111a and 112a, the signal light L11 gradually loses its power in response to the transmission loss occurring in the cores 111a and 112a. Hence, the power of the signal light L12 is at a lower level than the power of the signal light L11.

The communication device 300 outputs a signal light L21 having the predetermined wavelength to the core 112b of the multicore fiber 112. The signal light L21 represents an example of a second signal light. The core 112b transmits the signal light L21 and outputs it to the core 111b of the multicore fiber 111. The core 111b transmits the signal light L21 which has already propagated through the core 112b.

The communication device 200 receives a signal light L22 that represents the signal light L21 after it has propagated firstly through the core 112b and then through the core 111b. While sequentially propagating through the cores 112b and 111b, the signal light L21 gradually loses its power in response to the transmission loss occurring in the cores 112b and 111b. Hence, the power of the signal light L22 is at a lower level than the power of the signal light L21.

In the optical communication system 1000 configured in the manner explained above, in the multicore fiber connector 110, in the stage of that has a relatively higher power, the signal light L11 propagates through the core 111a that has a relatively larger effective core area; and, after the power decreases to a relatively lower level, the signal light L11 propagates through the core 112a that has a relatively smaller effective core area. Hence, it becomes possible to mitigate the effects of nonlinear optical phenomena occurring during the communication from the communication device 200 to the communication device 300. In the multicore fiber connector 110, in the stage of that has a relatively higher power, the signal light L21 propagates through the core 112b that has a relatively larger effective core area; and, after the power decreases to a relatively lower level, the signal light L21 propagates through the core 111b that has a relatively smaller effective core area. Hence, it becomes possible to mitigate the effects of nonlinear optical phenomena occurring during the communication from the communication device 300 to the communication device 200. Thus, in the optical communication system 1000, the multicore fiber connector 110 becomes able to mitigate the effects of optical phenomena occurring during the bidirectional communication carried out between the communication devices 200 and 300.

Moreover, in the multicore fiber connector 110, as a result of having different effective core areas, the cores 111a and 111b in the multicore fiber 111 are easily distinguishable when a cross-sectional surface of the multicore fiber 111 is observed under a microscope. Particularly, since the absolute value of the difference between the effective core areas of the cores 111a and 111b exceeds 10% of the smaller of the two effective core areas, the cores 111a and 111b may be distinguished with more ease. In an identical manner, the cores 112a and 112b in the multicore fiber 112 have different effective core areas. Particularly, the absolute value of the difference between the effective core areas of the cores 112a and 112b exceeds 10% of the smaller of the two effective core areas. Hence, when a cross-sectional is observed under the microscope, the cores 112a and 112b are easily distinguishable. For that reason, in the multicore fibers 111 and 112, even when a marker that has a different refractive index than the refractive index of the cladding portion and that does not contribute in the optical propagation is not provided in the cladding portion, the two cores are easily distinguishable.

In the multicore fiber 111, the cores 111a and 111b have mutually different effective core areas. As a result, the cores 111a and 111b function as heterogeneous cores, thereby enabling achieving reduction in the inter-core crosstalk. In an identical manner, in the multicore fiber 112, the cores 112a and 112b have mutually different effective core areas. That enables achieving reduction in the inter-core crosstalk.

As a result of the diligent study done by the present researchers, it was confirmed that, when the absolute value of the difference between the effective core areas of two cores at the predetermined wavelength is greater than the smaller of the two effective core areas by 10% or more, it is a desirable condition in achieving reduction in the inter-core crosstalk.

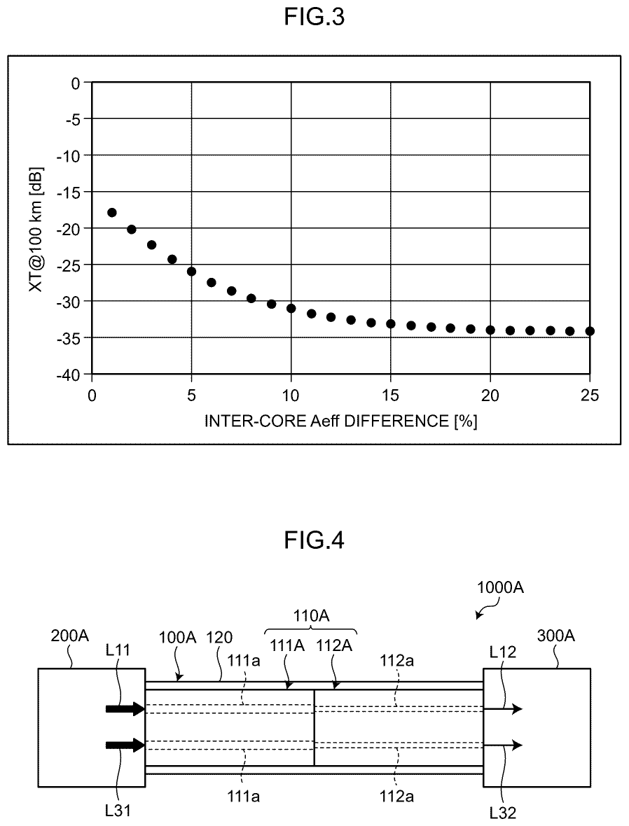

For example, FIG. 3 is a diagram illustrating an example of the relationship between the difference in the effective core areas (Aeff) of the cores and the inter-core crosstalk (XT). In FIG. 3 is illustrated a case in which there are four cores and the cladding portion has the outer diameter of 125 μm. The inter-core crosstalk (XT) represents the average value of the four cores. As illustrated in FIG. 3, when the difference between the effective core areas (Aeff) of the cores is greater than the smallest effective core area by 10% or more, it is a desirable condition in terms of holding down the inter-core crosstalk (XT) to be equal to smaller than-30 dB at the length of 100 km when the wavelength is equal to 1550 nm.

FIG. 4 is a schematic configuration diagram of an optical communication system in which a multicore fiber connector according to a second embodiment is used. An optical communication system 1000A is a unidirectional optical communication system that includes a multicore fiber cable 100A and communication devices 200A and 300A.

The multicore fiber cable 100A includes a multicore fiber connector 110A according to the second embodiment in place of the multicore fiber connector 110 of the multicore fiber cable 100 illustrated in FIG. 1.

The multicore fiber connector 110A is configured when multicore fibers 111A and 112A are directly connected to each other in series.

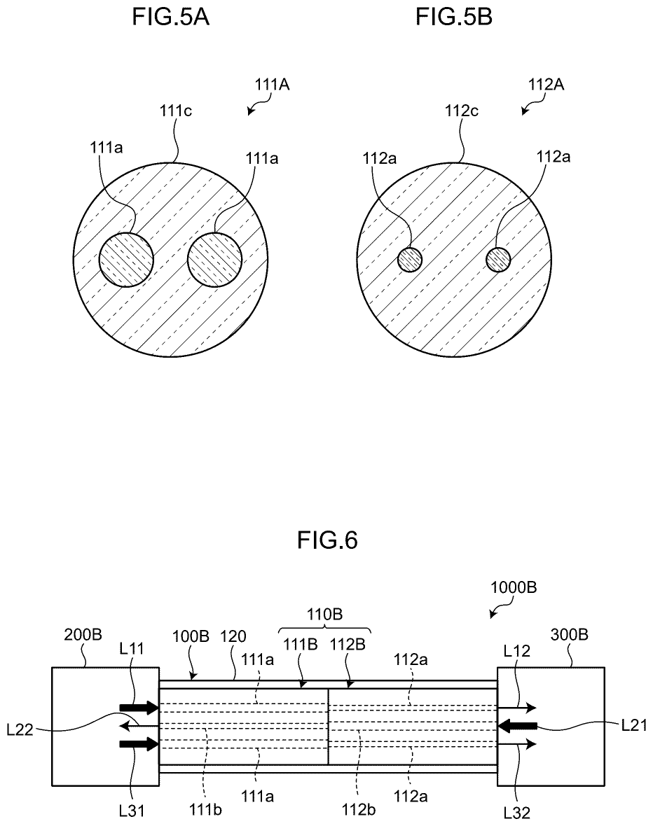

FIG. 5A and FIG. 5B are schematic cross-sectional views of the multicore fibers, which are illustrated in FIG. 4, along the surface perpendicular to the longitudinal direction. FIG. 5A is a cross-sectional view of the multicore fiber 111A, and FIG. 5B is a cross-sectional view of the multicore fiber 112A.

In the multicore fiber 111A, the core 111a is substituted for the core 111b of the multicore fiber 111 illustrated in FIG. 2A. In the multicore fiber 112A, the core 112a is substituted for the core 112b of the multicore fiber 112 illustrated in FIG. 2B.

As illustrated in FIG. 4, the cores 111a are directly connected to the corresponding cores 112a in series.

The communication devices 200A and 300A have a known configuration used in the unidirectional communication method implemented in optical fiber communication. The communication device 200A is connected to the multicore fiber cable 100A on the side of the multicore fiber 111. The communication device 300A is connected to the multicore fiber cable 100A on the side of the multicore fiber 112A.

The communication device 200A outputs signal lights L11 and L31 to the cores 111a of the multicore fiber 111A. The wavelength of the signal light L31 is present within the operating wavelength band, and may be either same as or different from the wavelength of the signal light L11. The core 111a, to which the signal light L31 is input, transmits the signal light L31 and outputs it to the core 112a of the multicore fiber 112A. The core 112a transmits the signal light L31 which has already propagated through the core 111a.

The communication device 300A receives a signal light L32 that represents the signal light L31 after it has propagated firstly through the core 111a and then through the core 112a. While sequentially propagating through the cores 111a and 112a, the signal light L31 gradually loses its power in response to the transmission loss occurring in the cores 111a and 112a. Hence, the power of the signal light L32 is at a lower level than the power of the signal light L31.

In the optical communication system 1000A configured in the manner explained above, it becomes possible to mitigate the effects of nonlinear optical phenomena occurring during the unidirectional communication carried out from the communication device 200 to the communication device 300.

FIG. 6 is a schematic configuration diagram of an optical communication system in which a multicore fiber connector according to a third embodiment is used. An optical communication system 1000B is a bidirectional optical communication system that includes a multicore fiber cable 100B and communication devices 200B and 300B.

The multicore fiber cable 100B includes a multicore fiber connector 110B according to the third embodiment in place of the multicore fiber connector 110 of the multicore fiber cable 100 illustrated in FIG. 1.

The multicore fiber connector 110B is configured when multicore fibers 111B and 112B are directly connected to each other in series.

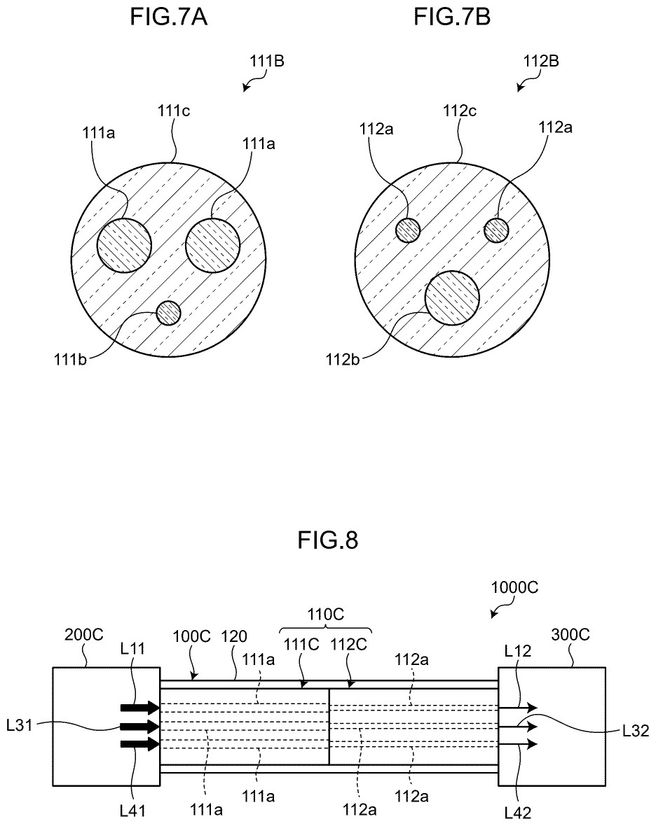

FIG. 7A and FIG. 7B are schematic cross-sectional views of the multicore fibers, which are illustrated in FIG. 6, along the surface perpendicular to the longitudinal direction. FIG. 7A is a cross-sectional view of the multicore fiber 111B, and FIG. 7B is a cross-sectional view of the multicore fiber 112B.

The multicore fiber 111B has a 3-core configuration achieved by adding the core 111b, which is illustrated in FIG. 2A, in the multicore fiber 111A illustrated in FIG. 5A. The two cores 111a and the core 111b are placed to form an equilateral triangular lattice in a cross-sectional view. The multicore fiber 112B has a 3-core configuration achieved by adding the core 112b, which is illustrated in FIG. 2B, in the multicore fiber 112A illustrated in FIG. 5B. The two cores 112a and the core 112b are placed to form an equilateral triangular lattice in a cross-sectional view.

As illustrated in FIG. 6, the cores 111a are directly connected to the corresponding cores 112a in series. Moreover, the cores 111b and 112b are directly connected to each other in series.

The communication devices 200B and 300B have a known configuration used in the bidirectional communication method implemented in optical fiber communication. The communication device 200B is connected to the multicore fiber cable 100B on the side of the multicore fiber 111B. The communication device 300B is connected to the multicore fiber cable 100B on the side of the multicore fiber 112B.

The communication device 200B outputs the signal lights L11 and L31 individually to the two cores 111a of the multicore fiber 111B.

The communication device 300B receives the signal lights S12 and L32 that respectively represent the signal lights L11 and L31 after they have propagated firstly through the corresponding cores 111a and then through the corresponding cores 112a.

Moreover, the communication device 300B outputs the signal light L21, whose wavelength is present within the operating wavelength band, to the core 111b of the multicore fiber 112B.

The communication device 200B receives the signal light L22 that represents the signal light L21 after it has propagated firstly through the core 112b and then through the core 111b.

In the optical communication system 1000B configured in the manner explained above, it becomes possible to mitigate the effects of nonlinear optical phenomena occurring during the bidirectional communication carried out between the communication devices 200B and 300B. Particularly, the optical communication system 1000B is suitable for the case in which a large volume of communication is carried out from the communication device 200B to the communication device 300B. Moreover, the multicore fiber connector 110B is favorable from the perspective of having distinguishability among the cores in a cross-sectional view and from the perspective of reducing the inter-core crosstalk.

FIG. 8 is a schematic configuration diagram of an optical communication system in which a multicore fiber connector according to a fourth embodiment is used. An optical communication system 1000C is a unidirectional optical communication system that includes a multicore fiber cable 100C and communication devices 200C and 300C.

The multicore fiber cable 100C includes a multicore fiber connector 110C according to the fourth embodiment in place of the multicore fiber connector 110 of the multicore fiber cable 100 illustrated in FIG. 1.

The multicore fiber connector 110C is configured when multicore fibers 111C and 112C are directly connected to each other in series.

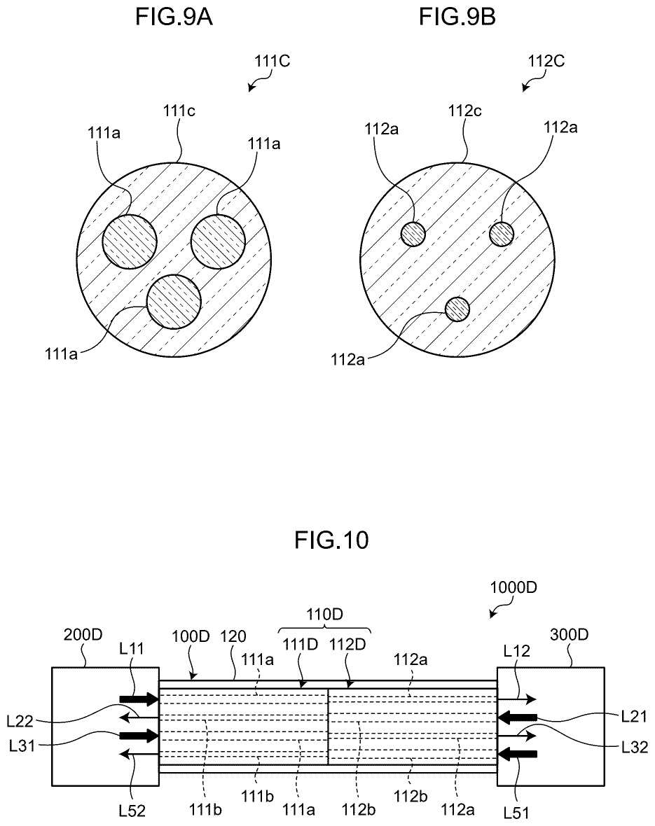

FIG. 9A and FIG. 9B are schematic cross-sectional views of the multicore fibers, which are illustrated in FIG. 8, along the surface perpendicular to the longitudinal direction. FIG. 9A is a cross-sectional view of the multicore fiber 111C, and FIG. 9B is a cross-sectional view of the multicore fiber 112C.

In the multicore fiber 111C, the core 111a is substituted for the core 111b of the multicore fiber 111B illustrated in FIG. 7A. In the multicore fiber 112C, the core 112a is substituted for the core 112b of the multicore fiber 112B illustrated in FIG. 7B.

As illustrated in FIG. 8, the cores 111a are directly connected to the corresponding cores 112a in series.

The communication devices 200C and 300C have a known configuration used in the unidirectional communication method implemented in optical fiber communication. The communication device 200C is connected to the multicore fiber cable 100C on the side of the multicore fiber 111C. The communication device 300A is connected to the multicore fiber cable 100C on the side of the multicore fiber 112C.

The communication device 200C outputs signal lights L11, L31, and L41 to the cores 111a of the multicore fiber 111C. The wavelength of the signal light L41 is present within the operating wavelength band, and may be either same as or different from the wavelength of the signal light L11 or the signal light L31. The core 111a, to which the signal light L41 is input, transmits the signal light L41 and outputs it to the corresponding core 112a of the multicore fiber 112C. The core 112a transmits the signal light L41 which has already propagated through the corresponding core 111a.

The communication device 300C receives a signal light L42 that represents the signal light L41 after it has propagated firstly through the core 111a and then through the core 112a. While sequentially propagating through the cores 111a and 112a, the signal light L41 gradually loses its power in response to the transmission loss occurring in the cores 111a and 112a. Hence, the power of the signal light L42 is at a lower level than the power of the signal light L41.

In the optical communication system 1000C configured in the manner explained above, it becomes possible to mitigate the effects of nonlinear optical phenomena occurring during the unidirectional communication carried out from the communication device 200 to the communication device 300.

FIG. 10 is a schematic configuration diagram of an optical communication system in which a multicore fiber connector according to a fifth embodiment is used. An optical communication system 1000D is a bidirectional optical communication system that includes a multicore fiber cable 100D and communication devices 200D and 300D. The multicore fiber cable 100D includes a multicore fiber connector 110D according to the fifth embodiment in place of the multicore fiber connector 110 of the multicore fiber cable 100 illustrated in FIG. 1.

The multicore fiber connector 110D is configured when multicore fibers 111D and 112D are directly connected to each other in series.

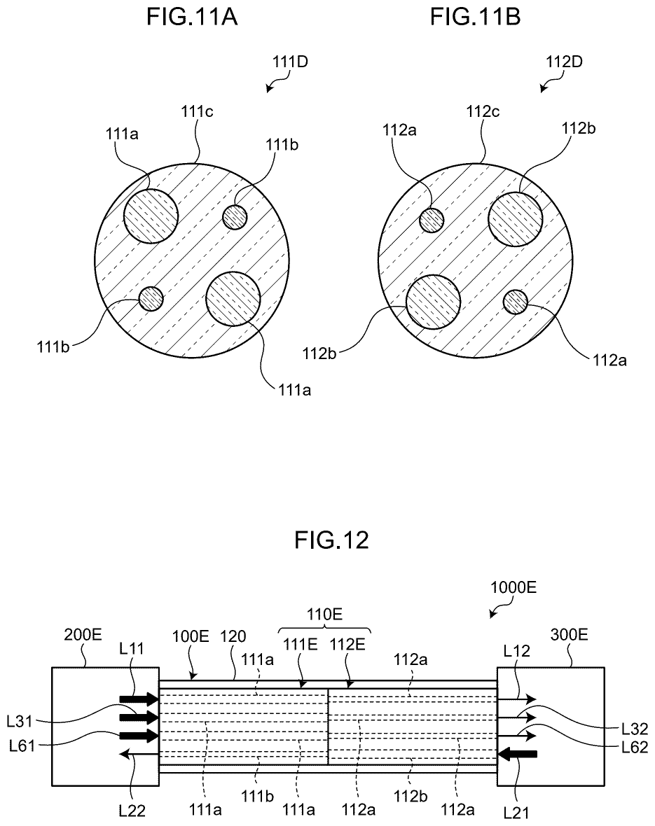

FIG. 11A and FIG. 11B are schematic cross-sectional views of the multicore fibers, which are illustrated in FIG. 10, along the surface perpendicular to the longitudinal direction. FIG. 11A is a cross-sectional view of the multicore fiber 111D, and FIG. 11B is a cross-sectional view of the multicore fiber 112D.

The multicore fiber 111D has a 4-core configuration achieved by adding the core 111b in the multicore fiber 111B illustrated in FIG. 7A. The two cores 111a and the two cores 111b are placed to form a square lattice in a cross-sectional view, with the identical cores positioned diagonal to each other. The multicore fiber 112D has a 4-core configuration achieved by adding the core 111b in the multicore fiber 112B illustrated in FIG. 7B. The two cores 111a and the two cores 111b are placed to form a square lattice in a cross-sectional view, with the identical cores positioned diagonal to each other.

As illustrated in FIG. 10, the cores 111a are directly connected to the corresponding cores 112a in series. Moreover, the cores 111b are directly connected to the corresponding cores 112b in series.

The communication devices 200D and 300D have a known configuration used in the bidirectional communication method implemented in optical fiber communication. The communication device 200D is connected to the multicore fiber cable 100D on the side of the multicore fiber 111D. The communication device 300D is connected to the multicore fiber cable 100D on the side of the multicore fiber 112D.

The communication device 200D outputs the signal lights L11 and L31 individually to the two cores 111a of the multicore fiber 111D.

The communication device 300D receives the signal lights L11 and L32 that represent the signal lights L11 and L31, respectively, after they have propagated firstly through the corresponding cores 111a and then through the corresponding cores 112a.

The communication device 300D outputs signal lights L21 and L51, whose wavelengths are present within the operating wavelength, individually to the two cores 112a of the multicore fiber 112D. The wavelength of the signal light L51 is present within the operating wavelength band, and may be either same as or different from the wavelength of the signal light L21.

The communication device 200D receives signal lights L22 and L52 that represent the signal lights L21 and L52, respectively, after they have propagated firstly through the corresponding cores 112b and then through the corresponding cores 111b.

In the optical communication system 1000D configured in the manner explained above, it becomes possible to mitigate the effects of nonlinear optical phenomena occurring during the bidirectional communication carried out between the communication devices 200D and 300D. Moreover, the multicore fiber connector 110D is favorable also from the perspective of having distinguishability among the cores in a cross-sectional view and from the perspective of reducing the inter-core crosstalk.

FIG. 12 is a schematic configuration diagram of an optical communication system in which a multicore fiber connector according to a sixth embodiment is used. An optical communication system 1000E is a bidirectional optical communication system that includes a multicore fiber cable 100E and communication devices 200E and 300E.

The multicore fiber cable 100E includes a multicore fiber connector 110E according to the sixth embodiment in place of the multicore fiber connector 110 of the multicore fiber cable 100 illustrated in FIG. 1.

The multicore fiber connector 110E is configured when multicore fibers 111E and 112E are directly connected to each other in series.

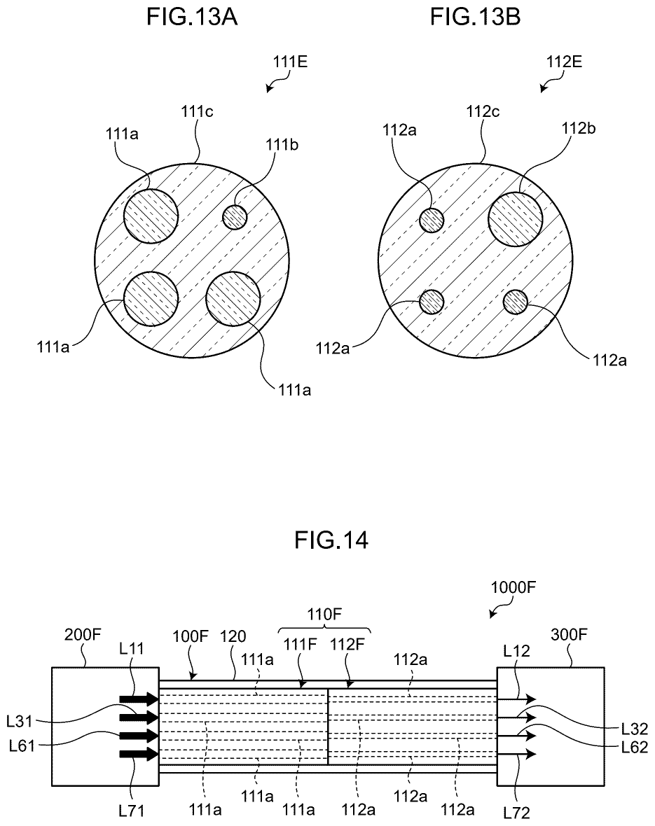

FIG. 13A and FIG. 13B are schematic cross-sectional views of the multicore fibers, which are illustrated in FIG. 12, along the surface perpendicular to the longitudinal direction. FIG. 13A is a cross-sectional view of the multicore fiber 111E, and FIG. 13B is a cross-sectional view of the multicore fiber 112E.

In the multicore fiber 111E, the core 111a is substituted for one of the cores 111b of the multicore fiber 111D illustrated in FIG. 11A. In the multicore fiber 112E, the core 112a is substituted for one of the cores 112b of the multicore fiber 112E illustrated in FIG. 11B.

As illustrated in FIG. 12, the cores 111a are directly connected to the corresponding cores 112a in series. Moreover, the cores 111b and 112b are directly connected to each other in series.

The communication devices 200E and 300E have a known configuration used in the bidirectional communication method implemented in optical fiber communication. The communication device 200E is connected to the multicore fiber cable 100E on the side of the multicore fiber 111E. The communication device 300E is connected to the multicore fiber cable 100E on the side of the multicore fiber 112E.

The communication device 200E outputs signal lights L11, L31, and L61, whose wavelengths are present within the operating wavelength band, individually to the cores 111a of the multicore fiber 111E. The wavelength of the signal light L61 is present within the operating wavelength band, and may be either same as or different from the wavelength of the signal light L11 or the signal light L31. The core 111a, to which the signal light L61 is input, transmits the signal light L61 and outputs it to the corresponding core 112a of the multicore fiber 112E. The core 112a transmits the signal light L61 which has already propagated through the corresponding core 111a.

The communication device 300E receives a signal light L62 that represents the signal light L61 after it has propagated firstly through the core 111a and then through the core 112a. While sequentially propagating through the cores 111a and 112a, the signal light L61 gradually loses its power in response to the transmission loss occurring in the cores 111a and 112a. Hence, the power of the signal light L62 is at a lower level than the power of the signal light L61.

In the optical communication system 1000E configured in the manner explained above, it becomes possible to mitigate the effects of nonlinear optical phenomena occurring during the bidirectional communication carried out between the communication devices 200E and 300E. Particularly, the optical communication system 1000E is suitable for the case in which a large volume of communication is carried out from the communication device 200E to the communication device 300E. Moreover, the multicore fiber connector 110E is favorable from the perspective of having distinguishability among the cores in a cross-sectional view and from the perspective of reducing the inter-core crosstalk.

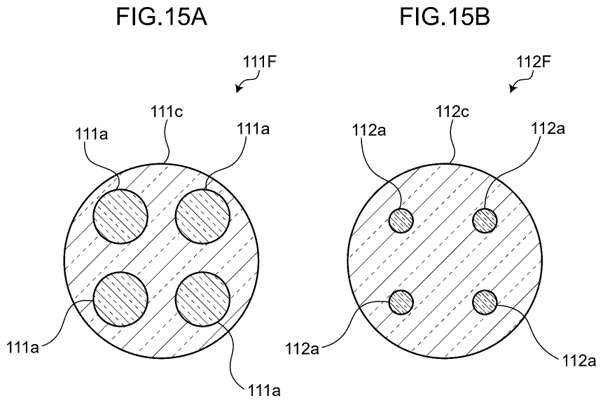

FIG. 14 is a schematic configuration diagram of an optical communication system in which a multicore fiber connector according to a seventh embodiment is used. An optical communication system 1000F is a unidirectional optical communication system that includes a multicore fiber cable 100F and communication devices 200F and 300F.

The multicore fiber cable 100F includes a multicore fiber connector 110F according to the seventh embodiment in place of the multicore fiber connector 110 of the multicore fiber cable 100 illustrated in FIG. 1.

The multicore fiber connector 110F is configured when multicore fibers 111F and 112F are directly connected to each other in series.

FIG. 15A and FIG. 15B are schematic cross-sectional views of the multicore fibers, which are illustrated in FIG. 14, along the surface perpendicular to the longitudinal direction. FIG. 15A is a cross-sectional view of the multicore fiber 111F, and FIG. 15B is a cross-sectional view of the multicore fiber 112F.

In the multicore fiber 111F, the core 111a is substituted for the core 111b of the multicore fiber 111E illustrated in FIG. 13B. In the multicore fiber 112F, the core 112a is substituted for the core 112b of the multicore fiber 112E illustrated in FIG. 13B.

As illustrated in FIG. 14, the cores 111a are directly connected to the corresponding cores 112a in series.

The communication devices 200F and 300F have a known configuration used in the unidirectional communication method implemented in optical fiber communication. The communication device 200F is connected to the multicore fiber cable 100F on the side of the multicore fiber 111F. The communication device 300F is connected to the multicore fiber cable 100F on the side of the multicore fiber 112F.

The communication device 200F outputs signal lights L11, L31, L61, and L71 to the cores 111a of the multicore fiber 111F. The wavelength of the signal light L71 is present within the operating wavelength band, and may be either same as or different from the wavelength of the signal light L11, the signal light L31, or the signal light L61. The core 111a, to which the signal light L71 is input, transmits the signal light L71 and outputs it to the corresponding core 112a of the multicore fiber 112F. The core 112a transmits the signal light L71 which has already propagated through the corresponding core 111a.

The communication device 300F receives a signal light L72 that represents the signal light L71 after it has propagated firstly through the corresponding core 111a and then through the corresponding core 112a. While sequentially propagating through the cores 111a and 112a, the signal light L71 gradually loses its power in response to the transmission loss occurring in the cores 111a and 112a. Hence, the power of the signal light L72 is at a lower level than the power of the signal light L71.

In the optical communication system 1000F configured in the manner explained above, it becomes possible to mitigate the effects of nonlinear optical phenomena occurring during the unidirectional communication carried out from the communication device 200F to the communication device 300F.

In the embodiments described above, regarding the cores having different effective core areas (herein, referred to as cores #1 and #2), exemplary combinations of the effective core areas at the wavelength of 1550 nm are given below in Table 1. However, the combinations given in Table 1 are only exemplary, and the present disclosure is not limited to those examples.

TABLE 1

| | | | | | | |
|---|---|---|---|---|---|---|
| Aeff [μm²] of core #1 | 80 | 80 | 80 | 110 | 110 | 125 |
| Aeff [μm²] of core #2 | 110 | 125 | 150 | 125 | 150 | 150 |

A multicore fiber that constitutes a multicore fiber connector according to an embodiment may be manufactured using, for example, a method called a boring method explained below.

For example, core preforms are manufactured using the known vapor-phase axial deposition (VPD) method or the known outside vapor deposition (OVD) method. The core preforms are preforms that include a portion forming part of the cladding portion meant for surrounding the portion of the cores in a multicore fiber.

Moreover, a cladding portion preform is prepared for use in forming the major portion of the cladding portion, and holes for inserting the core preforms are formed on the cladding portion preform in a number equal to the number of core preforms. After the holes are formed, a cleaning treatment may be performed to clean the inside of the holes.

Subsequently, one core preform is inserted into each hole formed on the cladding portion preform; integration is achieved by performed heat treatment, and an optical fiber preform is obtained. Moreover, using a known type of drawing furnace, a multicore optical fiber is drawn from the optical fiber preform.

The manufacturing method explained above was implemented and two types of 2-core multicore fibers (fibers #1 and #2) were manufactured. The core preforms were manufactured according to the VAD method. The cores were manufactured to have the refractive index profile of the trench type. At that time, the center core was made of pure silica glass; and the intermediate layer, the trench layer, and the cladding portion were made of silica glass including fluorine. The cladding portion was designed to have the outer diameter of 125 μm. The center-to-center distance between the cores (i.e., the core pitch) was designed to be equal to 48 μm.

With the cores of the fiber #1 being referred to as the cores #1 and #2, and the cores of the fiber #2 being referred to as the cores #3 and #4, in Table 2 are given the structural parameters and the optical properties of the fibers #1 and #2. Thus, regarding each core of a multicore fiber manufactured in the manner explained above, the structural parameters and the optical properties are given in Table 2. With reference to Table 2, “center core A” represents the relative refractive-index difference regarding the center cores, and “trench A” represents r the relative refractive-index difference regarding the trench layers. Moreover, “cladding ratio” represents the numerical value based on the refractive index of the cladding portion, and “pure silica ratio” represents the numerical value based on the refractive index of the pure silica glass. Furthermore, “cladding A” represents the relative refractive-index difference of the cladding portions based on the refractive index of the pure silica glass. Moreover, “center core 2a” represents the outer diameter of the center core, “b/a” represents the ratio of an outer diameter 2b of the intermediate layer with respect to the center core diameter 2a, and “c/a” represents the outer diameter 2c of a trench layer with respect to the center core 2a. Furthermore, “Acc” represents the cutoff wavelength. Moreover, “dispersion slope” represents a value in the zero-dispersion wavelength. Furthermore “bending loss @ 1550 nm/30 mmo” represents the bending loss at the wavelength of 1550 nm when the multicore fiber is bent with the diameter of 300 mm. Meanwhile, with respect to the cladding portion of the intermediate layer, the relative refractive-index difference was substantially equal to 0%.

As given in Table 2, in the fiber #1, the cores #1 and #2 had different effective core areas (Aeff) of 80 μm² and 125 μm², respectively, and the absolute value of the difference between those effective core areas was equal to or greater than 10% of 80 μm². On the other hand, in the fiber #2, the cores #3 and #4 had the same Aeff of 110 μm².

TABLE 2

| | Multicore fiber | | | |
|---|---|---|---|---|
| | Fiber #1 | | Fiber #2 | |
| | Core #1 | Core #2 | Core #3 | Core #4 |
| Center core Δ [%] | 0.35/0.09 | 0.25/0.09 | 0.29/0.09 | 0.29/0.09 |
| (cladding ratio/pure silica | | | | |
| ratio) | | | | |
| Trench Δ [%] | −0.15/−0.41 | −0.19/−0.35 | −0.17/−0.37 | −0.17/−0.37 |
| (cladding ratio/pure silica | | | | |
| ratio) | | | | |
| Cladding Δ [%] | −0.26 | −0.16 | −0.20 | −0.20 |
| (pure silica ratio) | | | | |
| Center core diameter 2a | 9.5 | 12.0 | 11.3 | 11.3 |
| [μm] | | | | |
| b/a | 1.8 | 2.0 | 1.9 | 1.9 |
| c/a | 3.2 | 3.5 | 3.3 | 3.3 |
| Aeff@1550 nm [μm²] | 80 | 125 | 110 | 110 |
| λ cc [nm] | 1411 | 1422 | 1403 | 1409 |
| Wavelength dispersion @ | 17.6 | 19.7 | 19.1 | 19.2 |
| 1550 nm [ps/nm/km] | | | | |
| Dispersion slope | 0.061 | 0.063 | 0.062 | 0.063 |
| [ps/nm²/km] | | | | |
| Bending loss @ 1550 | 0.05 | 0.11 | 0.14 | 0.13 |
| nm/30 mmφ [dB/m] | | | | |
| Transmission loss [dB/km] | 0.157 | 0.149 | 0.153 | 0.154 |

Subsequently, two fibers #1 having the length 50 km were prepared and were fusion-spliced to connect the respective cores #1 to each other in series and to connect the respective cores #2 to each other in series. With that, a multicore fiber connector according to the working example was manufactured. On the other hand, the fiber #2 having the length of 100 km was treated as the multicore fiber according to a comparison example. In the working example, the connection loss was equal to 0.1 dB.

In Table 3 is given the optical properties of the multicore fiber connector according to the working example and the multicore fiber according to the comparison example. Herein, “average span loss” represents the transmission per 100 km length. However, in the working example, when A represents ((the transmission loss in the core #1 representing the first core)+ (the transmission loss in the core #2 representing the second core)+ (the connection loss between the first core #1 and the second core #2)) and when B represents ((the transmission loss in the core #2 representing the first core)+ (the transmission loss in the core #1 representing the second core)+ (the connection loss between the first core #2 and the second core #1)), the “average span loss” represents the average value of A and B. Moreover, the equivalent Aeff represents the effective Aeff of two or more optical fibers as obtained by calculation from the comparison with the nonlinearity of NZ-DSF. Furthermore, “XT” represents the worst value among the inter-core crosstalk values measured under various conditions.

As given in Table 3, in the multicore fiber connector according to the working example, since the equivalent Aeff was greater than the equivalent Aeff according to the comparison example, the optical nonlinearity was low and the crosstalk characteristics were excellent.

TABLE 3

| | Average span | Equivalent Aeff | |
|---|---|---|---|
| | loss [dB] | [μm²] | XT [dB] |
| Working example | 15.35 | 113 | −38.6 |
| Comparison | 15.35 | 109 | −28.5 |
| example | | | |

In the embodiments described above, in the multicore fiber constituting the multicore fiber connector, the number of cores is equal to or greater than two and equal to or smaller than four. However, there may be more than four cores and, from the perspective of managing the cores, the number of cores may be equal to or smaller than 19. Alternatively, two multicore fibers having an equivalent design with two or four cores may be used, and the cores having mutually different equivalent Aeff may be connected to configure the bidirectional optical communication system according to the first embodiment or the fifth embodiment. As a result, while mitigating the effects of nonlinear optical phenomena and holding down the crosstalk, a multicore fiber connector having excellent manufacturability may be configured.

Moreover, in the embodiments described above, the multicore fiber connector includes only the first multicore fiber and the second multicore fiber, and the first cores and the second cores are directly connected in series. However, the present disclosure is not limited by that case. For example, as another embodiment, the multicore fiber connector may also include another multicore fiber other than the first multicore fiber and the second multicore fiber, and the first cores and the second cores may be indirectly connected in series via the other multicore fiber. In that case, in between the first core and the second core, either cores having the same value of the effective core area as the first cores may be connected; or cores having an intermediate effective core area between the effective core areas of the first cores and the second cores may be connected.

Moreover, from among the embodiments described above, in the embodiments in which the same cores are included in identical multicore fibers, the same cores may be changed to mutually different cores. In that case, from among the mutually different cores, two cores may have the absolute value of the difference between the effective core areas to be greater than the smaller effective core area, from among the effective core areas of the two cores at the predetermined wavelength, by 10% or more. For example, in the multicore fiber 111A of the multicore fiber connector 110A according to the second embodiment, one of the cores 111a may be substituted with a core having the effective core area to be greater than the effective core area of the cores 112a, and the absolute value of the difference between the effective core areas of the substituted core and the core 111a may be greater than the effective core area of the core 111a by 10% or more.

According to the present disclosure, it becomes possible to configure a multicore fiber connector that enables mitigating the effects of nonlinear optical phenomena occurring during optical communication.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A multicore fiber connector comprising:
a first multicore fiber including
a plurality of cores including a first core whose effective core area at a predetermined wavelength is equal to a first value, and
a cladding portion surrounding the plurality of cores; and
a second multicore fiber including
a plurality of cores including a second core whose effective core area at the predetermined wavelength is equal to a second value which is smaller than the first value, and
a cladding portion surrounding the plurality of cores, wherein
the first core and the second core are connected to each other in series.

2. The multicore fiber connector according to claim 1, wherein
only the first multicore fiber and the second multicore fiber are included as multicore fibers, and
the first core and the second core are directly connected to each other in series.

3. The multicore fiber connector according to claim 1, wherein each of the first multicore fiber and the second multicore fiber includes at least two cores between which absolute value of difference in effective core areas at the predetermined wavelength is greater than smaller effective core area, from among effective core areas of the two cores at the predetermined wavelength, by 10% or more.

4. The multicore fiber connector according to claim 1, wherein
the plurality of cores of the first multicore fibers include a third core whose effective core area at the predetermined wavelength is equal to a third value,
the plurality of cores of the second multicore fibers include a fourth core whose effective core area at the predetermined wavelength is equal to a fourth value which is greater than the third value, and
the third core and the fourth core are connected to each other in series.

5. The multicore fiber connector according to claim 1, wherein, in the first multicore fiber or the second multicore fiber, number of the cores is equal to or smaller than 19.

6. The multicore fiber connector according to claim 1, wherein, in the first multicore fiber or the second multicore fiber, number of the cores is equal to or greater than two and equal to or smaller than four.

7. The multicore fiber connector according to claim 1, wherein, in the first multicore fiber or the second multicore fiber, a marker that has a different refractive index than refractive index of the cladding portion and that does not contribute in optical propagation is not provided in the cladding portion.

8. An optical communication system comprising:
a multicore fiber cable including the multicore fiber connector according to claim 1;
a first communication device configured to output a first signal light to the first core; and
a second communication device configured to receive the first signal light which has propagated firstly through the first core and then through the second core.

9. An optical communication system comprising:
a multicore fiber cable including the multicore fiber connector according to claim 4;
a first communication device configured to output a first signal light to the first core; and
a second communication device configured to receive the first signal light which has propagated firstly through the first core and then through the second core, wherein
the second communication device is configured to output a second signal light to the fourth core, and
the first communication device is configured to receive the second signal light which has propagated firstly through the fourth core and then through the third core.
